(19) United States
(12) Patent Application Publication
(10) Pub. No.: US 2012/0186194 A1
(43) Pub. Date: Jul. 26, 2012

(54) CLOSING MEANS

(75) Inventor: Ulrich Schlieper, Rettenbach (DE)

(73) Assignee: KRONES AG, Neutraubling (DE)

(21) Appl. No.: 13/355,669

(22) Filed: Jan. 23, 2012

(30) Foreign Application Priority Data
Jan. 25, 2011 (DE) 102011003118.9

(51) Int. Cl. B67B 3/20

(52) U.S. Cl. 53/317

(57) ABSTRACT

A closing means for containers including a transport means for the containers having a drive and at least one closing unit for applying a closure by a linear motion along a central line and a rotary motion about the central line, wherein the rotary motion is applied by rolling off two gear members. To achieve a structurally simple and flexible embodiment the first one of the gear members is connected with a separate drive independent of the drive of the transport means.

### CROSS-REFERENCE TO RELATED APPLICATION

The present application claims the benefit of priority of German Application No. 102011003118.9, filed Jan. 25, 2011. The entire text of the priority application is incorporated herein by reference in its entirety.

### FIELD OF THE DISCLOSURE

The disclosure relates to a closing means for containers, such as used in beverage bottling operations.

### BACKGROUND

Such a closing means is known, for example, from EP-A-1 103 513.The known closing means is part of a bottling plant for beverage containers, in particular bottles, and contains a bearing central column which is driven by a drive to rotate about a vertical axis. Mountings for the containers and one closing unit each allocated to each mounting and rotating about the vertical axis together with the central column are arranged at the central column. In the region of the closing units, a stationary frame is furthermore provided at which a cam curve is fixed on which the closing unit rolls off with a roller array such that a predetermined lifting motion of the closing unit along the extended central line of the container can take place, so that a closure can be placed onto the container from above. At the frame, a rotary drive for the closing unit is furthermore provided by means of which, for example, screw caps can be screwed onto the containers. The rotary drive contains a first gear member in the form of a gearwheel which is rotatably mounted at the stationary frame. A second gear member in the form of a gearwheel is located at the periphery of the closing unit and moves with the latter about the vertical axis of the support. Both gear members are engaged, so that the gear members mutually roll off and the closing unit is thereby rotated. The drive of the closing unit is thus derived from the drive of the transport means. By this, however, the sense of rotation and the rotational speed are fixed. Moreover, this type of drive requires extensive retrofitting measures if special customer requests must be considered.

It is furthermore known from WO 2008/145363 to equip each closing unit of a closing means with a separate motor. This, however, is extremely cost-intensive.

### SUMMARY OF THE DISCLOSURE

One aspect of the disclosure thus is to provide a closing means which, in a structurally simple manner, offers higher flexibility when it comes to fulfill the customers' requests for the closing means.

By the embodiment according to the disclosure, the advantages of the gear members in view of a simple construction and a fail-safe, robust embodiment are maintained, while flexibility is increased by a separate drive of the first one of the gear members. By the drive, the speed can be adapted to the particularly employed screw cap, and the torque to the material of the screw cap and the container, moreover, rotary motions into both directions are easily possible.

Particularly suited as a drive is a torque motor due to its simple and robust embodiment and its good controllability; it is preferably employed with a hollow shaft design and an outer rotor. Torque motors are relatively compact, so that their rotor can have a smaller outer diameter than the partial circle of the mountings of the containers in the closing means, and thus they permit a compact design.

The drive can be easily seated on the rotating support which acts as a drive for the transport means, in particular when a hollow shaft motor is used. The torque motor thus moves together with the support and independent of it, so that changes in the transport speed can be easily included in the drive speed of the closing means.

As gear members, the well-tried gearwheels can be employed, though frictional guide rollers or the like are also possible.

Despite a separate drive, it is also possible to drive all closing units of a closing means by one single separate drive by maintaining the gear members.

To compensate the linear motions along the container's central line, one of the gear members is extended, so that the engagement is maintained across the total length of the linear motion.

Another possibility of increasing flexibility when considering customer requests, which can be provided together with or independent of the separate independent drive is the embodiment of the closing unit in a modular way, wherein the various functions are each combined in one assembly, so that, for example, various rotating assemblies match the same lifting assembly, or various lifting assemblies match the same rotating assembly, and can be exchanged depending on the type of container to be handled by the user.

In addition or as an alternative, the closing unit can also comprise an exchangeable closing head which is adapted to different closure constructions.

The closing units can be held ready for any type of container or closure and optionally also be held ready for retrofitting closing means already in operation.

### BRIEF DESCRIPTION OF THE DRAWINGS

One embodiment of the disclosure will be illustrated more in detail below with reference to the drawings. In the drawings:

FIG. 1 shows a perspective partial representation of a closing means according to the disclosure,

FIG. 2 shows an axial section of the closing means according to FIG. 1,

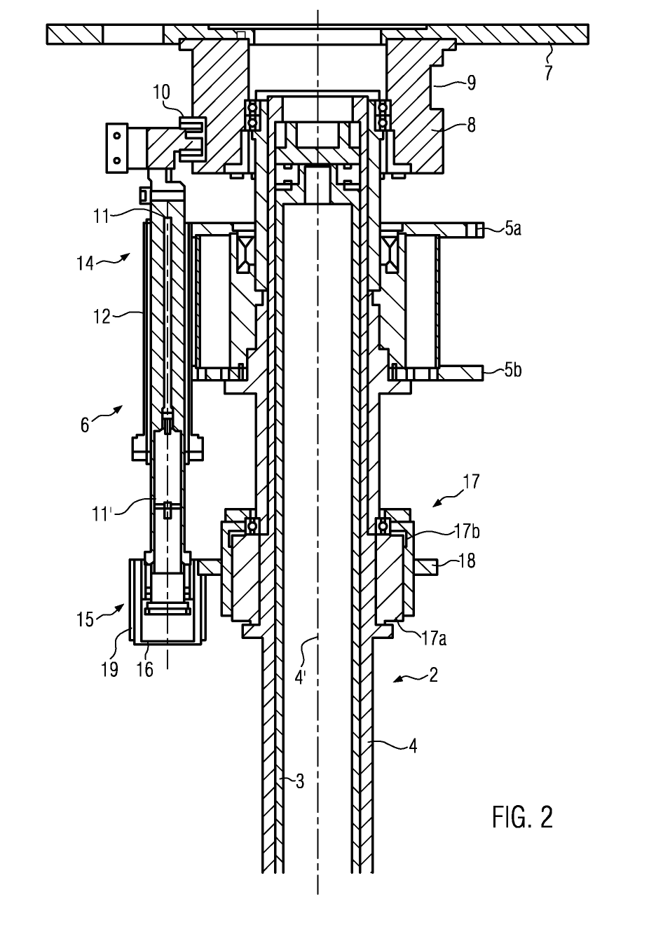

FIGS. 3 to 5 show different embodiments of closing units.

### DETAILED DESCRIPTION OF THE PREFERRED EMBODIMENT

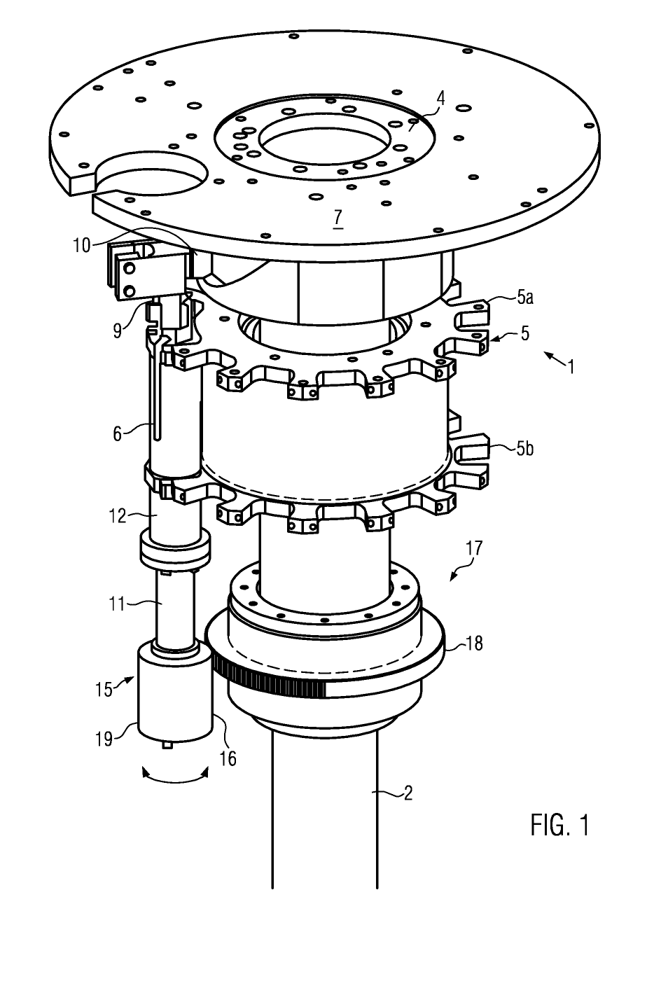

FIG. 1 shows, in a perspective schematic partial representation, a closing means 1 of an essentially conventional design. The closing means 1 contains a vertical central column 2 which comprises an inner, not generally, but vertically stationary support 3, and an outer rotary sleeve 4 driven about its vertical central line 4′. The mountings for the containers and a mounting 5 for at least one closing unit 6 are fixed on the rotary sleeve 4 in a common, not shown way. The mounting 5 in the represented embodiment contains two partial circles 5a and 5b lying one upon the other and keeping the closing units 6 at a peripheral distance with respect to each other.

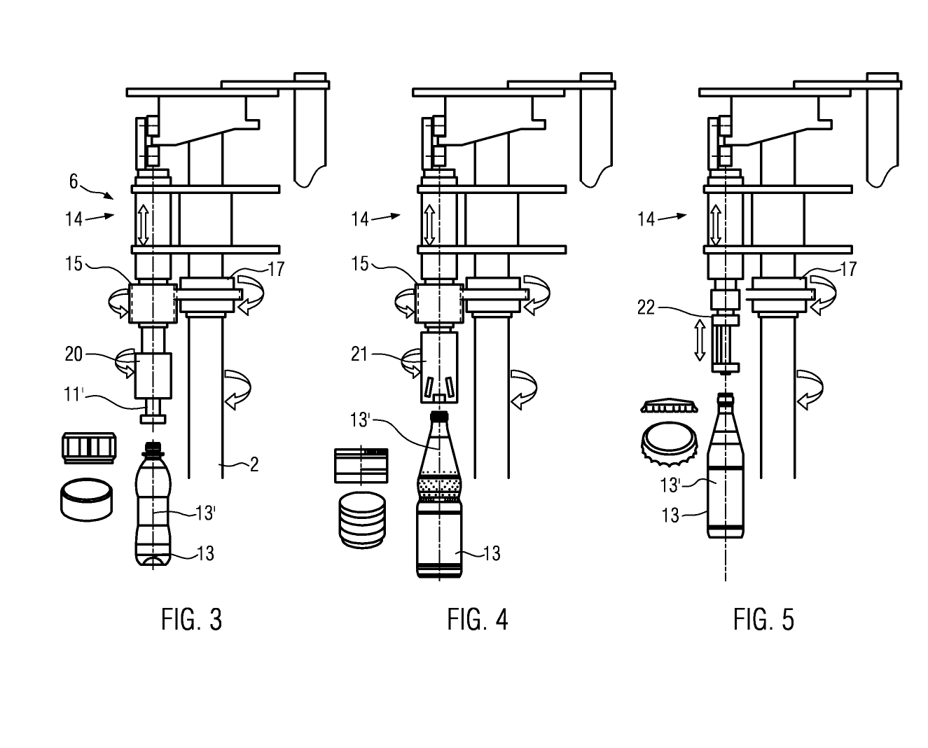

Above the central column 2, a stationary head plate 7 is provided at which a cam curve 9 is arranged at a flange 8 projecting downwards, into which cam curve a guide roller 10 engages in a known manner, the guide roller being rotatably mounted at the closing unit 6. A lifting cylinder 11 is connected with the guide roller 10 and arranged in a guide bush 12 to be shiftable in the vertical direction, i.e. in the direction of the oriented central lines 11′ of the lifting cylinder 11 and the central line 13′ of a container 13 (FIG. 3). The guide bush 12 is connected to the mounting 5. The guide roller 10 and the lifting cylinder 11 form a lifting assembly 14.

Instead of by the cam curve 9, lifting can also be accomplished electromotively or pneumatically.

At the lower level of the lifting cylinder 11 facing away from the guide roller 10, a rotating assembly 15 is fixed to be rotatable about the central axis 11′ of the lifting cylinder 11. Mounting is effected such that the two assemblies 14 and 15 are fixed to each other to be exchangeable.

The rotating assembly 15 contains a bush-like support 16 which comprises, at the lower end facing away from the lifting cylinder 11, either a stationarily arranged closing head or a coupling which is able to exchangeably receive various types of closing heads.

The drive of the rotating assemblies 15 of all closing units 6 is effected via a separate drive 17 which is independent of the (not shown) drive of the central column. Preferably, the drive is effected via a hollow shaft motor, in particular a so-called torque motor in a hollow shaft design, which is seated with its hollow stator 17a on the rotary sleeve 4 of the central column 2 without connection to the cam curve 9 and rotates with it about the central line 4′, and an outer rotor 17b which is, at its outer side, provided with a first gear member 18 in the form of a gearwheel, a pinion or a toothed ring which extends coaxially about the central line 4′ of the rotary sleeve 4. The motor and the bearing here form a unit.

This first gear member 18 of the drive 17 drives, via a second gear member 19, the rotating assembly 15 in the desired sense of rotation separately and independent of the drive of the rotary sleeve 4 of the central column 2. The second gear member 19 is also a gearwheel, but has an axial length in the direction of the central line 11′ which is longer than the axial length of the first gear member 18 and at least as large as the stroke distance of the lifting cylinder 11 effected by the cam curve 4, so that in each phase of the lifting motion, the drive 17 acts on the rotating assembly 15. The second gear member 19 is, in the represented embodiment, fixed at the outer surface of the sleeve 16.

The control of the drive 17 and its power supply are effected via cables which preferably extend inside the central column 2, and e.g. a slip ring transmitter, or in a contactless manner.

With the embodiment according to the disclosure, thus the screwing on of screw caps of any type can be done in both directions and exactly controlled with a given torque, so that the containers are well closed, without there being any risk of damages.

By the modular design, the closing means according to the disclosure can be structurally simply adapted to certain user requirements, either already during manufacture, or for retrofitting.

Furthermore, a position-measuring system can be provided which traces the degree of screwing on the closures onto the containers and correspondingly controls the drive 17. The position-measuring system can detect the speed of the closing head and optionally control it, for which e.g. a rotary encoder is arranged between the rotor and the stator. However, it is also possible to detect the speed of the closing head in the region of the gear member 19.

FIGS. 3 to 5 show different possibilities of using the closing means according to the disclosure. FIG. 3 shows the use of the closing means according to the disclosure for applying screw caps. To this end, the container 13 is oriented with its central line 13′ aligned with the central line 11′ of the lifting cylinder, and a closing head 20 for applying screw caps or a gripper closing head or the like are inserted into the rotating assembly 15. The central column 2 is driven and the drive 17 started to actuate the assemblies of the closing unit 6 by a combined linear motion in the vertical direction (lift) and rotary motion about the vertical axis 11′ for screwing the screw cap onto the container 13.

FIG. 4 shows a closing means according to the disclosure for applying aluminum roll-on closures onto containers 13. As FIG. 4 shows, the closing means according to FIG. 4 corresponds to the closing means according to FIG. 3 with respect to the lifting assembly 14 and the rotating assembly 15. Only the closing head was changed, i.e. replaced by an aluminum roll-on head 21 which can apply these aluminum roll-on closures.

FIG. 5 shows a closing means according to the disclosure, equipped for applying crown caps. The closing unit here contains the lifting assembly 14, while the rotating assembly was removed and a crown cap closing head 22 or an aluminum sealing head or the like was fixed directly to the lifting assembly 14. The drive 17 is thus put out of service, but it can remain at its place if one expects another retrofitting to screw caps.

In variation to the described and drawn embodiment, the closing unit can also be embodied with a head drive, preferably if the modular or assembly design is not necessary. The rotary or screw drive is also located above the mounting for the containers. The torque motor can be easily encapsulated, i.e. accommodated in a protective housing which only exposes the toothed ring, so that cleaning is highly facilitated. Instead of the torque motor, other motors can be employed, preferably with a hollow shaft. Finally, the two gear members do not necessarily have to be engaged directly, intermediate members can also be provided. The described drive can also be provided in closing units without assembly division, and the assembly components can also be provided without separate drive.

1. A Closing means for containers, comprising a transport means for the containers provided with a transport means drive and at least one closing unit for applying a closure by a linear motion along a central line (11′) and a rotary motion about the central line, the rotary motion being applied by rolling off two gear members, and the first one of the gear members is connected with a separate drive independent of the transport means drive.

2. The closing means according to claim 1, wherein the drive of the gear member is effected via a torque motor.

3. The closing means according to claim 1, wherein the drive of the gear member comprises a hollow shaft stator and an outer rotor.

4. The closing means according to claim 3, wherein the transport means drive comprises a rotating column on which the stator of the drive of the gear member is seated, wherein the first gear member is connected to the rotor.

5. The closing means according to claim 1, wherein the two gear members are gearwheels.

6. The closing means according to claim 1, wherein the transport means comprises a plurality of closing units each provided with a second gear member, and each second gear member being in transmitting connection with the first gear member.

7. The closing means according to claim 1, wherein at least one of the gear members has a height in the direction of the central line adapted to the length of the linear motion.

8. The closing means according to claim 1, wherein the closing unit comprises a lifting assembly and a rotating assembly provided with the second gear member which are fixed to each other to be exchangeable.

9. The closing means according to claim 1, wherein the closing unit comprises an exchangeable closing head.

10. The closing means according to claim 1, wherein the closing unit comprises a screw head at the outer surface of which the second gear member is arranged.

11. The closing means according to claim 1, and a position-measuring system for controlling the drive of the gear member.

12. A closing unit for the closing means of claim 1, comprising a lifting assembly and a rotating assembly which are exchangeably fixed to each other.

13. The closing unit according to claim 12, and a closing head which is exchangeably fixed to one of the lifting assembly and the rotating assembly.
